(19) United States
(12) Patent Application Publication
(10) Pub. No.: US 2026/0227519 A1
(43) Pub. Date: Aug. 6, 2026

(54) OBSTACLE DETECTION APPARATUS, TRAVELING BODY, OBSTACLE DETECTION METHOD, AND RECORDING MEDIUM

(71) Applicants: Kento HOSAKA, Tokyo (JP); Koichi KUDO, Kanagawa (JP)

(72) Inventors: Kento HOSAKA, Tokyo (JP); Koichi KUDO, Kanagawa (JP)

(21) Appl. No.: 19/149,854

(22) PCT Filed: Mar. 14, 2024
(86) PCT No.: PCT/IB2024/052444

§ 371 Date: Jul. 22, 2025

(30) Foreign Application Priority Data
Mar. 23, 2023 (JP) 2023-047196
Nov. 29, 2023 (JP) 2023-201928

(51) Int. Cl. G01S 17/931; G01S 17/42; G01S 17/89

(52) U.S. Cl. CPC G01S 17/931; G01S 17/42; G01S 17/89

(57) ABSTRACT

An obstacle detection apparatus includes a three-dimensional range sensor and an obstacle detection unit. The three-dimensional range sensor is disposed on a front side of a traveling body in a traveling direction in which the traveling body travels on a road surface and has an irradiation angle of laser beam being a depression angle relative to the road surface. The obstacle detection unit detects an obstacle on the road surface by using a height map based on three-dimensional road surface data obtained from data acquired by the three-dimensional range sensor. The height map holds height information indicating a height from the road surface.

### TECHNICAL FIELD

Embodiments of the present disclosure relate to an obstacle detection apparatus, a traveling body, an obstacle detection method, and a recording medium.

### BACKGROUND ART

Safety technology for detecting obstacles and stopping or avoiding obstacles is necessary for traveling robots that autonomously travel outdoors. Various sensors such as a red, green, and blue (RGB) depth camera (so-called an RGB D camera), a stereo camera, a radar, and an ultrasonic sensor are used for safety technologies. Currently, sensors employing light detection and ranging or laser imaging detection and ranging (LiDAR) sensors are often used in safety technologies. LiDAR is a technology for measuring, for example, the distance to an object and the shape of the object based on information of light reflected from the object by irradiating the object with laser light. In particular, two-dimensional (2D) LiDAR sensors having the capability of detecting obstacles on a two-dimensional plane are often used. Patent Literature (PTL) 1 discloses a technology of performing, with a ranging device, one-dimensional laser scanning K times, and detecting an obstacle having a recessed shape successively in all the scans from (K-a)th scan to the K-th scan.

### CITATION LIST

### Patent Literature

[PTL 1]
Japanese Unexamined Patent Application Publication No. 2000-075032

### SUMMARY OF INVENTION

### Technical Problem

However, according to the related art, sensor data is acquired as a result of irradiation of a road surface with a line of laser beams in a lateral direction, i.e., in two dimensions, as viewed from a traveling robot. Accordingly, it is possible that, when the traveling robot travels on, for example, a steep slope, the approach angle of the traveling robot to the road surface becomes steeper, and the irradiation of the road surface with the two-dimensional laser beams is insufficient. In such a case, the traveling robot fails to acquire the sensor data, and the detection of obstacles on the road surface is difficult.

In view of the foregoing, an object of the present disclosure is to make road surface obstacle detection using three-dimensional sensor data less susceptible to influences of fluctuations in the approach angle of a traveling body to the road surface.

### Solution to Problem

In one aspect, an obstacle detection apparatus includes a three-dimensional range sensor and an obstacle detection unit. The three-dimensional range sensor is disposed on a front side of a traveling body in a traveling direction in which the traveling body travels on a road surface and has an irradiation angle of laser beam being a depression angle relative to the road surface. The obstacle detection unit detects an obstacle on the road surface by using a height map based on three-dimensional road surface data obtained from data acquired by the three-dimensional range sensor. The height map holds height information indicating a height from the road surface.

In another aspect, a traveling body includes a driver to travel on a road surface, a three-dimensional range sensor, and an obstacle detection unit. The three-dimensional range sensor is disposed on a front side of the traveling body in a traveling direction in which the driver travels and has an irradiation angle of laser beam being a depression angle relative to the road surface. The obstacle detection unit detects an obstacle on the road surface by using a height map based on three-dimensional road surface data obtained from data acquired by the three-dimensional range sensor. The height map holds height information indicating a height from the road surface.

In another aspect, an obstacle detection method includes generating a height map based on three-dimensional road surface data obtained from data acquired by a three-dimensional range sensor. The height map holds height information indicating a height from a road surface. The three-dimensional range sensor is disposed on a front side of a traveling body in a traveling direction in which the traveling body travels on the road surface and has an irradiation angle of laser beam being a depression angle relative to the road surface. The method further includes detecting an obstacle on the road surface by the height map.

In another aspect, a recording medium stores a plurality of program codes which, when executed by one or more processors, causes the processors to perform the method described above.

### Advantageous Effects of Invention

According to one aspect of the present disclosure, road surface obstacle detection using three-dimensional sensor data can be less susceptible to influences of fluctuations in the approach angle of a traveling body to the road surface.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is an exterior perspective view of a traveling apparatus according to a first embodiment of the present disclosure.

FIG. 2 is a block diagram illustrating a hardware configuration of the traveling apparatus according to the first embodiment.

FIG. 3 is a block diagram illustrating a functional configuration related to autonomous traveling of the traveling apparatus according to the first embodiment.

FIG. 4 is a block diagram illustrating a functional configuration related to the speed control of a steering control unit according to the first embodiment.

FIG. 5 is a diagram illustrating an outline of curb detection according to the first embodiment.

FIG. 6 is a diagram illustrating an outline of ditch detection according to the first embodiment.

FIG. 7A is a diagram illustrating a result of obstacle detection on a road surface according to the first embodiment.

FIG. 7B is a diagram illustrating a result of obstacle detection on a road surface according to the first embodiment.

FIG. 8 is a flowchart of a process of obstacle detection on a road surface performed by the traveling apparatus according to the first embodiment.

FIG. 9 is a flowchart of a process of storing point-cloud data according to the first embodiment.

FIG. 10 is a flowchart of a process of generating a height map according to the first embodiment.

FIG. 11 is a diagram illustrating an outline of noise removal according to the first embodiment.

FIG. 12 is a diagram illustrating a result of noise removal according to the first embodiment.

FIG. 13 is a flowchart of a process of generating a height obstacle map according to the first embodiment.

FIG. 14 is a flowchart of a process of generating a differential obstacle map according to the first embodiment.

FIG. 15 is a flowchart of a process of generating a ditch obstacle map according to the first embodiment.

FIG. 16 is a flowchart of a process of generating an obstacle map according to the first embodiment.

FIG. 17 is a diagram illustrating an overview of additional processing on the obstacle map according to the first embodiment.

FIG. 18 is a diagram illustrating a result of application of the additional processing on the obstacle map according to the first embodiment.

FIG. 19 is a diagram illustrating a deceleration range and a stop range of the traveling apparatus according to the first embodiment.

FIG. 20A is a diagram illustrating a change in a detection range with the turning radius of the traveling apparatus according to the first embodiment.

FIG. 20B is a diagram illustrating a change in a detection range with the turning radius of the traveling apparatus according to the first embodiment.

FIG. 21 is a diagram illustrating a detection area and representative points of an obstacle by costmap according to the first embodiment.

FIG. 22 is a diagram illustrating a method of calculating the distance to an obstacle according to the first embodiment.

FIG. 23 is a side view of a traveling apparatus according to a second embodiment of the present disclosure.

FIG. 24 is a plan view of the traveling apparatus according to the second embodiment, as viewed from above.

FIG. 25 is a diagram illustrating actual measurement data according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Descriptions are given below in detail of an obstacle detection apparatus, a traveling body, an obstacle detection method, and a program with reference to the drawings.

A description is given of a first embodiment of the present disclosure.

### Configuration of Traveling Apparatus

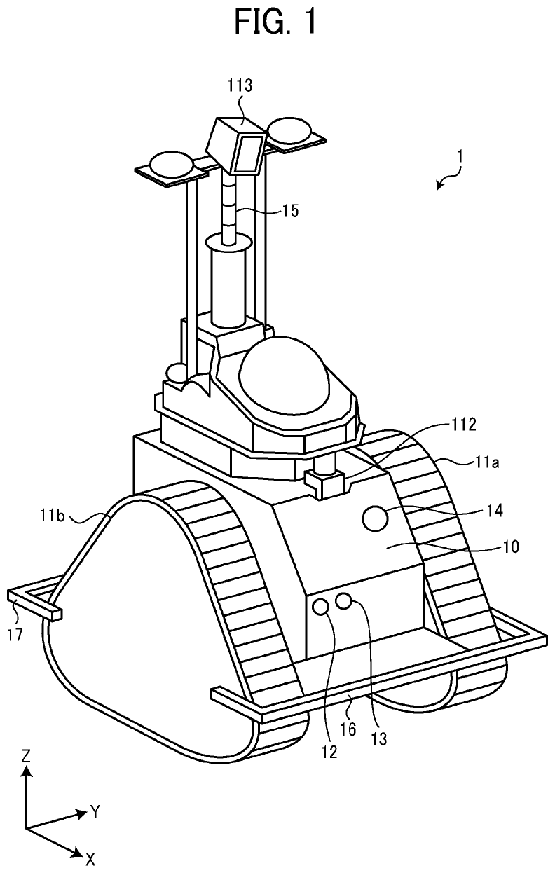

FIG. 1 is an exterior perspective view of a traveling apparatus 1 according to the first embodiment.

In the present specification, the Y direction matches the lateral width direction of the traveling apparatus 1. Further, the X direction matches a traveling direction of the traveling apparatus 1, and the Z direction matches the height direction of the traveling apparatus 1. The coordinates represented by X, Y, and Z may be referred to as robot coordinates in the following description. In other words, the robot coordinates are coordinates centered on the traveling apparatus 1.

The traveling apparatus 1 as a traveling body includes crawler traveling bodies 11a and 11b and a main body 10.

The crawler traveling bodies 11a and 11b are units serving as drivers of the traveling apparatus 1. Each of the crawler traveling bodies 11a and 11b is a crawler traveling body using a metallic or rubber belt.

Compared with a traveling body that travels with tires, such as an automobile, the crawler traveling body has a wider contact area with the ground and can travel more stably even in, for example, an environment with bad footing. While the traveling body that travels with the tires requires space to make a turn, the traveling apparatus having the crawler traveling body can perform a so-called spin turn, which enables a smooth turn even in a limited space.

In this disclosure, a spin turn refers to turning on the spot with the center of the body as an axis by rotating the left and right crawler belts in opposite directions at a constant speed.

The two crawler traveling bodies 11a and 11b are installed with the main body 10 interposed therebetween such that the traveling apparatus 1 can travel. The number of crawler traveling bodies is not limited to two and may be three or more. For example, the traveling apparatus 1 may include three crawler traveling bodies arranged in parallel such that the traveling apparatus 1 can travel. Alternatively, the traveling apparatus 1 may include, for example, four crawler traveling bodies arranged on the front, rear, right, and left sides like the tires of an automobile.

The crawler traveling bodies 11a and 11b (also collectively “crawler traveling bodies 11”) each have a triangular shape. The triangular crawler traveling bodies 11 are advantageous in that, when, for example, the front-rear length of the traveling body has a constraint, the contact area of the crawler traveling body with the ground is maximized within the constraint. Such a configuration can increase the stability in traveling as described above. In the case of a so-called tank crawler having an upper side (drive wheel side) longer than a lower side (idler wheel side), when a constraint is imposed on the front-rear direction length, the contact area with the ground is generally small, making traveling unstable. As described above, the crawler traveling bodies 11 is effective in increasing traveling performance, especially when applied to the traveling apparatus 1 that is relatively small.

The main body 10 supports the crawler traveling bodies 11a and 11b to travel and functions as a controller that controls the driving of the traveling apparatus 1. In addition, the main body 10 includes a battery to supply electric power for driving the crawler traveling bodies 11a and 11b.

The main body 10 of the traveling apparatus 1 includes a power button 12, a start button 13, an emergency stop button 14, a state indicator lamp 15, and bumpers 16 and 17.

The power button 12 is an operation device to be pressed by a person around the traveling apparatus 1 to turn on or off the power of the traveling apparatus 1. The start button 13 is an operation device to be pressed by a person around the traveling apparatus 1 to start the two crawler traveling bodies 11a and 11b. The emergency stop button 14 is an operation device to be pressed by a person around the traveling apparatus 1 to stop the traveling apparatus 1 being traveling.

The state indicator lamp 15 is an example of a notification device to indicate the state of the traveling apparatus 1. When the state of the traveling apparatus 1 changes due to, for example, a decrease in the remaining battery level, the state indicator lamp 15 lights up to notify a person nearby of the state change of the traveling apparatus 1. The state indicator lamp 15 lights up also in response to the detection of possibility of an abnormality such as the detection of an obstacle that obstructs the traveling of the traveling apparatus 1.

Although the traveling apparatus 1 in FIG. 1 includes one state indicator lamp 15, the number of state indicator lamp 15 is not limited thereto and may be two or more. In alternative to or in addition to the state indicator lamp 15, the notification device may use, for example, a speaker to output an alert sound indicating a state of the traveling apparatus 1.

The bumpers 16 and 17 are disposed on the front side and the rear side of the main body 10, respectively, and protect, for example, the main body 10 and the crawler traveling bodies 11a and 11b of the traveling apparatus 1.

The traveling apparatus 1 includes a range sensor 112 for horizontal detection. The range sensor 112 is disposed at a height of 0.5 meter on a front side of the traveling apparatus 1 in the traveling direction of the main body 10. The range sensor 112 for horizontal detection is a two-dimensional (2D) LiDAR sensor that performs detection by light and two-dimensional range finding. The range sensor 112 may employ micro-electro-mechanical systems (MEMS) or a rotary mirror.

The range sensor 112 irradiates an object with laser light, measures the time for the laser light to be reflected back from the object, and calculates the distance to the object and the direction of the object based on the measured time. The range sensor 112 has the capability of measuring a 270-degree range with the front X direction as a center. The traveling apparatus 1 measures the distance to an object in a wide horizontal range using the range sensor 112 and uses the distance as obstacle information.

The traveling apparatus 1 further includes a range sensor 113 for oblique direction detection. The range sensor 113 is disposed at a height of 0.9 meter and a depression angle of 30 degrees, on the front side of the main body 10 in the traveling direction of the main body 10. This installation position is determined to allow the range sensor 113 to detect the traveling road surface up to a position in front of the bumper 16 on the front side of the traveling apparatus 1. The range sensor 113 for oblique direction detection is a three-dimensional LiDAR (3D LiDAR) sensor having the capability of three-dimensional range finding. The range sensor 113 may employ MEMS or a rotary mirror.

The 3D LiDAR sensor used as the range sensor 113 employs a non-repetitive scanning method and can measure a conical range of 70.4 degrees as viewed from the center of the sensor detection surface and can measure distances up to 90 meters. The non-repetitive scanning method is scanning in a flower-like pattern while shifting the phase little by little in the horizontal and vertical directions, and is characterized in that the point cloud coverage in the measurement range is increased by the accumulation of time. The range sensor 113 is installed at an angle inclined down from the horizontal surface such that the irradiation angle of the laser beam is at a predetermined depression angle relative to a horizontal traveling road surface.

The range sensor 113 irradiates an object, such as an obstacle on the road surface, with laser light, measures the distance to the object and the direction of the object based on the time for the laser light to be reflected back from the object, and obtains the result of measurement as data.

For the installation position of the range sensor 113, an appropriate value depends on the widths and lengths of the crawlers of the crawler traveling bodies 11a and 11b and the sizes, widths, depths, and heights of objects to be detected.

### Hardware Configuration of Traveling Apparatus

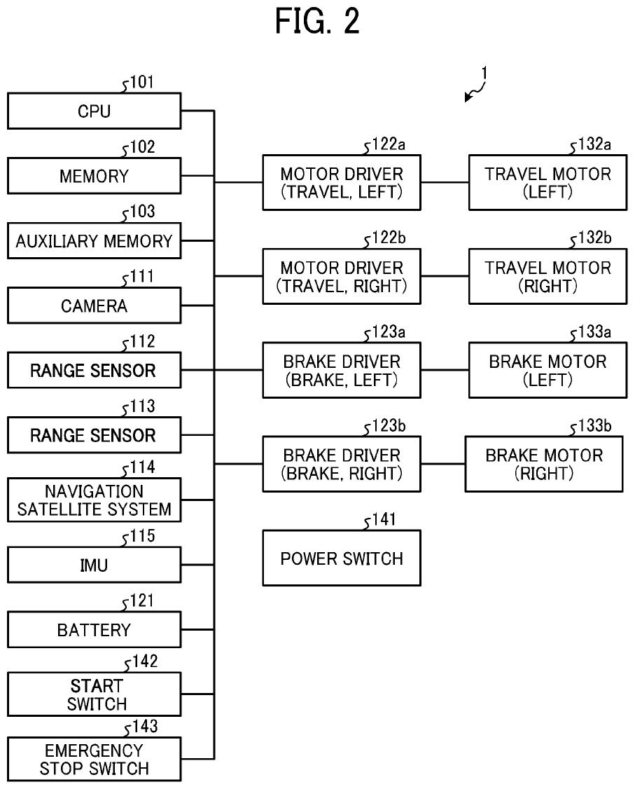

Referring to FIG. 2, a hardware configuration of the traveling apparatus 1 according to the present embodiment is described below. FIG. 2 is a block diagram illustrating a hardware configuration of the traveling apparatus 1 according to the present embodiment.

As illustrated in FIG. 2, the traveling apparatus 1 includes a central processing unit (CPU) 101, a memory 102, an auxiliary memory 103, a camera 111, the range sensors 112 and 113, a navigation satellite system 114, an inertial measurement unit (IMU) 115, a battery 121, motor drivers 122a and 122b (left and right), brake drivers 123a and 123b (left and right), travel motors 132a and 132b (left and right), brake motors 133a and 133b (left and right), a power switch 141, a start switch 142, and an emergency stop switch 143.

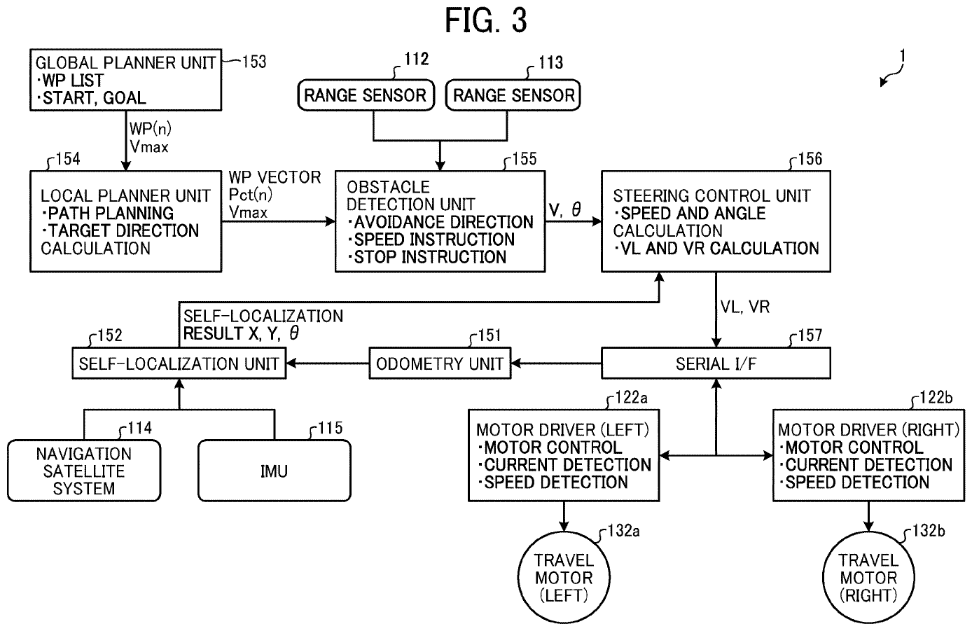

The CPU 101 controls the entire operation of the traveling apparatus 1. The CPU 101 operates according to a travel program stored in the memory 102 to implement an obstacle detection unit 155 (illustrated in FIG. 3). The CPU 101 operates according to a travel program stored in the memory 102 to travel using an obstacle map generated by the obstacle detection unit 155. The memory 102 is a temporary storage area for the CPU 101 to execute programs such as a controlling travel program. The auxiliary memory 103 stores data such as the travel program executed by the CPU 101.

The travel program to be executed on the traveling apparatus 1 may be a file installable or executable by a computer and stored on a computer-readable recording medium, such as a compact disc read-only memory (CD-ROM), a flexible disk (FD), a compact disc-recordable (CD-R), or a digital versatile disk (DVD).

The travel program to be executed on the traveling apparatus 1 may be stored on a computer connected to a network, such as the Internet, and may be downloaded through the network from the computer. Alternatively, the travel program executed on the traveling apparatus 1 may be provided or distributed via a network such as the Internet. Further, the travel program executed on the traveling apparatus 1 may be preloaded in, for example, a ROM of the traveling apparatus 1.

The motor drivers 122a and 122b (collectively “motor drivers 122”) are drivers for the travel motors 132a and 132b (collectively “travel motors 132”) included in the two crawler traveling bodies 11a and 11b, respectively. The brake drivers 123a and 123b (collectively “brake drivers 123”) are drivers for the brake motors 133a and 133b (collectively “brake motors 133”) included in the two crawler traveling bodies 11a and 11b, respectively.

The motor drivers 122 and the brake drivers 123 receive commands from the CPU 101 to control the travel motors 132 and the brake motors 133, respectively.

The power switch 141 is a switch that turns on or off the power of the traveling apparatus 1. The power switch 141 operates in conjunction with the pressing of the power button 12 (see FIG. 1) described above. The start switch 142 is a switch for starting the crawler traveling bodies 11a and 11b. The start switch 142 operates in conjunction with the pressing of the above-described start button 13 (see FIG. 1A). The emergency stop switch 143 is a switch for stopping the crawler traveling bodies 11a and 11b in an emergency. The emergency stop switch 143 operates in conjunction with pressing of the above-described emergency stop button 14 (see FIG. 1A).

Examples of the camera 111 include a spherical camera, a stereo camera, and an infrared camera. As described above, the range sensor 112 is a 2D LiDAR sensor for horizontal detection. As described above, the range sensor 113 is a 3D LiDAR sensor for oblique direction detection.

The navigation satellite system 114 receives radio waves from a satellite and measures the position of the traveling apparatus 1 on the earth based on the received result. The navigation satellite system 114 uses a Real Time Kinematic (RTK)-Global Navigation Satellite System (GNSS).

In the position determination (localization) using RTK-GNSS positioning, when a high-accuracy positioning solution (Fix solution) in the RTK-GNSS positioning is obtained, high accuracy with an error of about several centimeters is achieved.

The navigation satellite system 114 includes two antennas for GNSS reception. The navigation satellite system 114 determines that the reliability (accuracy) of the position information is low when there is a difference of a certain distance or more between the position information obtained by the above-mentioned two antennas.

The IMU 115 includes a triaxial accelerometer sensor and a rotational angular velocity sensor. The traveling apparatus 1 detects the tilt amount of the main body 10 of the traveling apparatus 1 using the measurement data of the IMU 115 and corrects the height difference relative to the traveling road surface measured by the range sensor 113 based on the tilt amount of the traveling apparatus 1.

The IMU 115 is preferably disposed in the vicinity of the range sensor 113. When the range sensor 113 is mounted on the main body 10 via an arm, the IMU 115 is preferably mounted on the arm. In the present embodiment, the IMU 115 also serves as an IMU for self-localization for determining the posture of the traveling apparatus 1.

This configuration can eliminate the inconvenience that the height position detected by the range sensor 113 changes as the main body 10 traveling on the rough ground shakes back and forth.

The CPU 101 functioning as the obstacle detection unit 155 detects the obstacle based on a parameter for determination that suits the crawler traveling bodies 11a and 11b of the traveling apparatus 1. This parameter enables such a setting that ditches having a certain width and obstacles having a certain height that the crawler traveling bodies 11a and 11b of the traveling apparatus 1 can pass are not to be detected as obstacles.

A description is given below of an operation related to autonomous traveling of the traveling apparatus 1.

FIG. 3 is a block diagram illustrating a functional configuration related to the autonomous traveling of the traveling apparatus 1 according to the present embodiment. As illustrated in FIG. 3, the autonomous traveling of the traveling apparatus 1 involves a function related to self-localization of the traveling apparatus 1 using the navigation satellite system 114 and a function related to traveling control of the traveling apparatus 1.

First, the self-localization of the traveling apparatus 1 will be described.

As illustrated in FIG. 3, the traveling apparatus 1 includes an odometry unit 151 and a self-localization unit 152 to perform functions related to self-localization of the traveling Regarding the self-localization of the traveling apparatus 1, the high-accuracy position information using the navigation satellite system 114 is used as described above. However, the position update cycle is about 200 milliseconds to 1 second and has large variations. For this reason, the odometry unit 151 performs odometry calculation for determining the self-position of the traveling apparatus 1 from rotation angles ω of the travel motors 132a and 132b that drive the two crawler traveling bodies 11a and 11b, respectively. The rotation angles ω of the travel motors 132a and 132b can be obtained from a hall sensor pulse for driving the travel motors 132a and 132b or an external sensor such as an encoder or a tachometer.

The self-localization unit 152 outputs a self-localization result (X, Y, θ). The self-localization unit 152 corrects the odometry information calculated by the odometry unit 151 to achieve stable self-localization. More specifically, the self-localization unit 152 corrects the odometry information using the position information obtained by the navigation satellite system 114 (including the RTK-GNSS) and a posture change measured by the IMU 115.

Incidentally, the position information by the RTK-GNSS may be suddenly shifted by several tens of centimeters to several meters due to the influence of, for example, a reflecting object. To prevent such a sudden shift in the self-localization from resulting in an unstable operation, the self-localization unit 152 corrects the above-described odometry information calculated by the odometry unit 151 when a difference between the individual position information acquired by the above-mentioned two antennas is within a certain amount. By contrast, when the difference between the individual position information acquired by the above-mentioned two antennas is equal to or greater than the certain amount, or when the high-accuracy positioning solution (Fix solution) in the RTK-GNSS positioning is not obtained, the self-localization unit 152 performs self-localization using only the calculation result by the odometry unit 151.

A description is given below of the speed control of the traveling apparatus 1.

As illustrated in FIG. 3, the traveling apparatus 1 includes a global planner unit 153, a local planner unit 154, the obstacle detection unit 155, and a steering control unit 156 to perform functions related to the speed control of the traveling apparatus 1.

The global planner unit 153 performs global planning to output a sequence of reachable waypoints (WP (n)) from a start point to a goal. Waypoints are a set of points on the traveling route of the traveling apparatus 1. A waypoint has information on the direction and the velocity (Vmax) in addition to the position (x, y, z).

Based on the waypoints (WP (n)) information obtained from the global planner unit 153, the local planner unit 154 actually plans a path connecting the waypoints and calculates a target direction (WP vector), target position coordinates Pct(n), and the velocity (Vmax).

The obstacle detection unit 155 performs obstacle detection or determination based on the detection result of the range sensors 112 and 113. The obstacle detection unit 155 outputs an avoidance direction (θ), a speed instruction (V), and a stop instruction (V) to the steering control unit 156 in accordance with the detected obstacle. The obstacle detection unit 155 further generates the obstacle map of the road surface on which the traveling apparatus 1 travels using the result of obstacle detection.

The steering control unit 156 calculates the speed and the angular velocity of the traveling apparatus 1 and calculates the velocities (VL and VR) of the right and left crawler traveling bodies 11a and 11b for steering control. The steering control unit 156 transfers the velocities (VL and VR) of the right and left crawler traveling bodies 11a and 11b to a serial interface (I/F) 157 and the motor drivers 122a and 122b, to control the travel motors 132a and 132b.

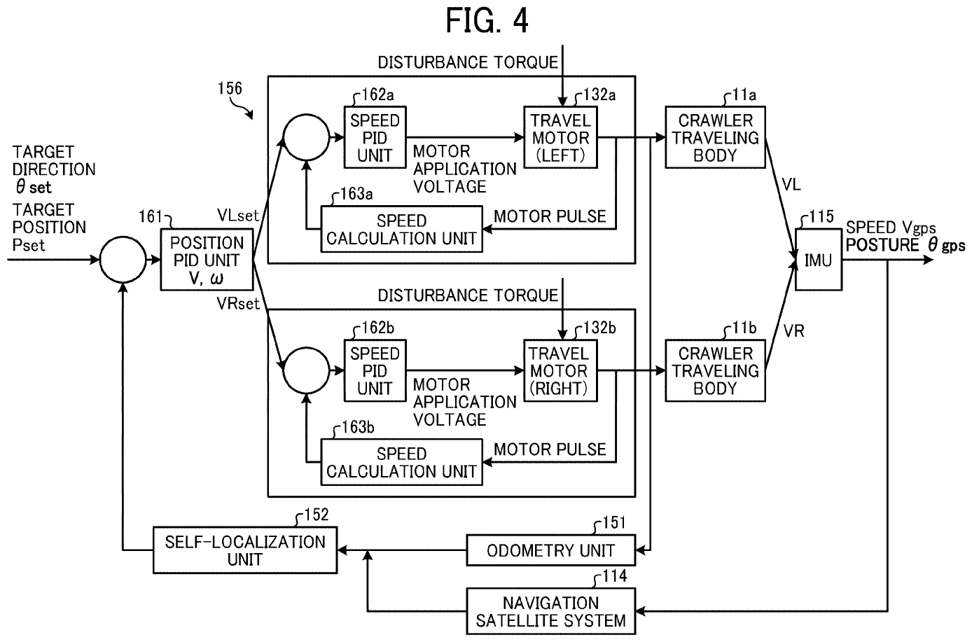

A description is given of a functional configuration related to speed control performed by the steering control unit 156 according to the present embodiment. FIG. 4 is a block diagram illustrating a functional configuration related to the speed control performed by the steering control unit 156.

The traveling apparatus 1 is a crawler robot that independently drives the right and left crawler traveling bodies 11a and 11b. The traveling apparatus 1 turns by a speed difference between the right and left crawler traveling bodies 11a and 11b. For stable traveling on various road surfaces with different traveling loads, the left and right crawler traveling bodies 11a and 11b are rotated at a designated speed regardless of the load.

For this reason, as illustrated in FIG. 4, the steering control unit 156 executes the traveling control of the traveling apparatus 1 that is divided into a major loop for controlling the steering and a minor loop for controlling the speeds of the left and right crawler traveling bodies 11a and 11b.

As illustrated in FIG. 4, the steering control unit 156 includes a position proportional integral derivation (PID) unit 161, speed PID units 162a and 162b, and speed calculation units 163a and 163b.

The position PID unit 161 calculates, from the difference (positional deviation) between the set value and the measured value, operation amounts VLset and VRset of the left and right crawler traveling bodies 11a and 11b (instructed speed V and the rotation angle ω of the travel motors 132a and 132b) for steering control.

The speed PID unit 162a and 162b obtain changes in the operation amounts from the speed deviation.

The speed calculation units 163a and 163b determine motor speeds based on signals (motor pulses) of hall sensors attached to the travel motors 132a and 132b.

In the major loop, the steering control unit 156 calculates differences (positional deviations) between a self-localization result and a target position (Pset) and a target direction (Oset) to the target point (Pset). To obtain the self-localization result, the odometry unit 151 performs odometry calculation using the motor pulses of the travel motors 132a and 132b, and the self-localization unit 152 corrects the odometry result using the position information obtained by the navigation satellite system 114 including the RTK-GNSS, and a posture change (gps) and a speed change (Vgps) measured by the IMU 115.

More specifically, the steering control unit 156 outputs the calculated difference (position deviation) to the position PID unit 161.

The position PID unit 161 calculates, from the difference (positional deviation) between the set value and the measured value, operation amounts VLset and VRset of the left and right crawler traveling bodies 11a and 11b (instructed speed V and the rotation angle ω of the travel motors 132a and 132b) for steering control.

The traveling apparatus 1 can travel stably with the left and right crawler traveling bodies 11a and 11b controlled in accordance with the operation amounts VLset and VRset from the major loop.

In addition, in the minor loop, the steering control unit 156 determines, with the speed calculation units 163a and 163b, the motor speeds based on the signals (motor pulses) of the hall sensors attached to the travel motors 132a and 132b. Then, based on the difference (speed deviation) between the speed determination result from the speed calculation units 163a and 163b and the target speed, the steering control unit 156 controls the voltage applied to the travel motors 132a and 132b with the speed PID units 162a and 162b, to perform feedback control of the speed. The reason for this speed feedback control by the minor loop is to minimize speed fluctuations due to disturbance torque to the travel motors 132a and 132b.

### Example of Obstacle Detection of Traveling Apparatus

A description is given below of the detection of an obstacle on the road surface on which the traveling apparatus 1 travels, in the control of the autonomous traveling of the traveling apparatus 1.

The detection of an obstacle on the road surface on which the traveling apparatus 1 travels is outlined as follows. The traveling apparatus 1 performs vibration correction by plane detection on the data obtained from the range sensor 113, which is a 3D LiDAR sensor mounted obliquely downward, and then superimposes the corrected data over time to acquire detailed road surface data. The traveling apparatus 1 converts the obtained vibration-corrected detailed road surface data into a height map in which the maximum height as height information is held in cells of a two-dimensional map such that the relationship in height in the front-rear, left-right, and oblique directions can be grasped. Then, an obstacle is determined from the difference in height of the height map.

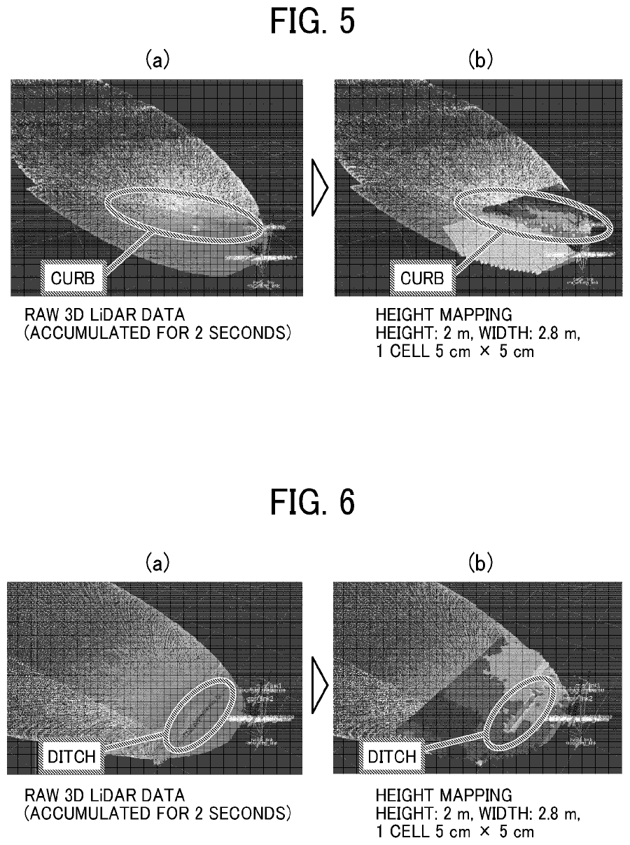

FIG. 5 is a diagram illustrating an outline of curb detection according to the present embodiment. The traveling apparatus 1 accumulates raw data of 3D LiDAR illustrated in (a) of FIG. 5, obtained from the range sensor 113 for 2 seconds and then generates a height map illustrated in (b) of FIG. 5. Note that, although FIGS. 5 and 6 are in monochrome, the original data indicates the height in rainbow gradient, i.e., red, orange, yellow, green, cyan, blue, and violet in this order. In the height map illustrated in (b) of FIG. 5 or 6, the difference in color is clearer than the raw data illustrated in (a) of FIG. 5 or 6. The traveling apparatus 1 determines whether a projection is a curb from the difference in height and the smoothness using the height map data.

More specifically, the obstacle detection unit 155 of the traveling apparatus 1 detects as a curb a projecting portion that satisfies a) a height difference from the ground is equal to or greater than a threshold value (on a height obstacle map) and b) the differentiated value from a neighboring cell on the two-dimensional map is equal to or greater than a threshold value (on a differential obstacle map) on the height map in (b) of FIG. 5.

FIG. 6 is a diagram illustrating an outline of ditch detection according to the present embodiment. The traveling apparatus 1 accumulates raw data of 3D LiDAR illustrated in (a) of FIG. 6 obtained from the range sensor 113 for 2 seconds and then generates a height map illustrated in (b) of FIG. 6. The obstacle detection unit 155 determines whether a recessed portion is a ditch by clustering cells on the two-dimensional map having a height difference from the ground equal to or smaller than a threshold value using the height map data. Specifically, the obstacle detection unit 155 of the traveling apparatus 1 clusters cells on the two-dimensional map having a height difference from the ground being equal to or smaller than a threshold value, and determines, as a ditch, a cluster of cells having a differentiated value with respect to the neighboring cell being equal to or greater than a threshold value among the cells on the two-dimensional map. When a ditch candidate cluster has one or more pieces of high edge information, the entire ditch candidate cluster is determined as a ditch.

Such a process enables detection of aerial objects in addition to road surface obstacles such as curbs and ditches as obstacles. Further, obstacles in front of the traveling apparatus 1 or obstacles at a steep approach angle are detected. Basically, the obstacle detection unit 155 determines whether an obstacle is present from a created height map but performs processes respectively dedicated to projecting obstacles, such as a curb (referred to as a curb obstacle in the following description), and recessed obstacles, such as a ditch (referred to as a ditch obstacle in the following description), respectively.

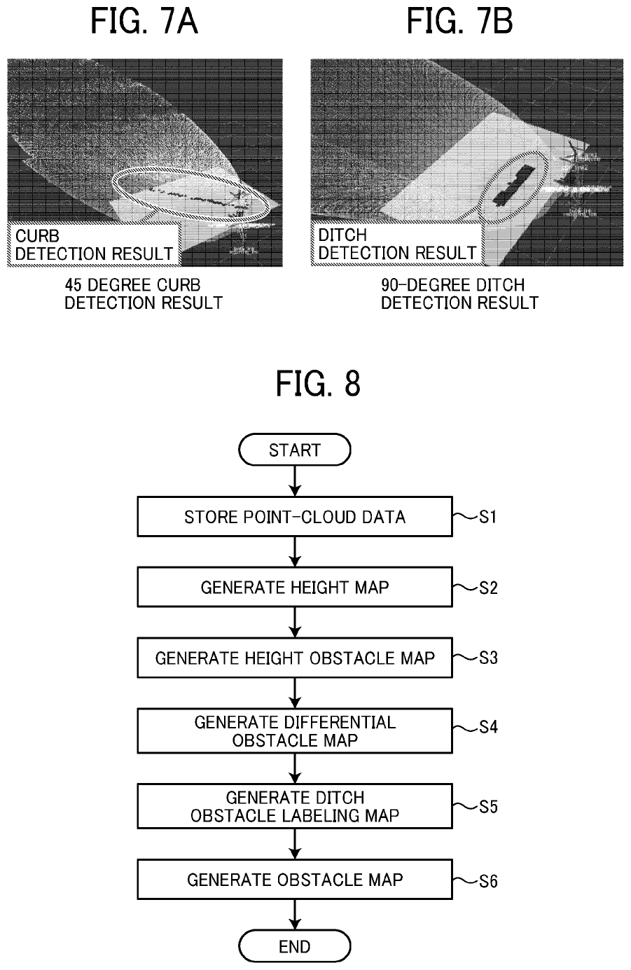

FIGS. 7A and 7B are diagrams each illustrating a result of the obstacle detection on a road surface according to the present embodiment. FIG. 7A illustrates a result of the curb detection, and FIG. 7B illustrates a result of the ditch detection. FIG. 7A illustrates the result of the curb detection at the approach angle of 45 degrees. FIG. 7B illustrates the result of the ditch detection in front of the traveling apparatus 1. The black cells on the two-dimensional map indicate road surface obstacles.

The processes respectively dedicated to projecting obstacles and recessed obstacles are performed, and their processing results are integrated to detect both projecting obstacles and recessed obstacles on the road surface. A description is given below of a detailed process of obstacle detection according to the present embodiment with reference to a flowchart.

FIG. 8 is a flowchart of a process of obstacle detection on a road surface performed by the traveling apparatus 1 according to the present embodiment.

As illustrated in FIG. 8, the obstacle detection unit 155 detects obstacles by sequentially performing processes of storing point-cloud data (step S1), generating a height map (step S2), generating a height obstacle map (step S3), generating a differential obstacle map (step S4), generating a ditch obstacle labeling map (step S5), and generating an obstacle map (step S6). Each of the processes will be described below in detail in order.

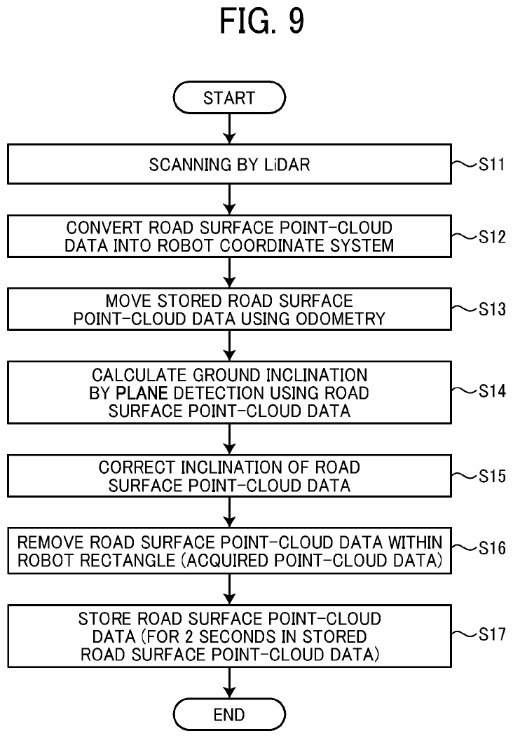

First, a description is given below of the process of storing point-cloud data (step S1). FIG. 9 is a flowchart of the process of storing point-cloud data according to the present embodiment.

As illustrated in FIG. 9, the obstacle detection unit 155 starts scanning by the range sensor 113 for oblique direction detection (step S11).

The obstacle detection unit 155 then converts the point-cloud data acquired by the range sensor 113 into the robot coordinates of the traveling apparatus 1, and generates road surface point-cloud data which is traveling road surface data (step S12). In this way, based on the data obtained from the three-dimensional range sensor, the obstacle detection unit 155 generates the traveling road surface data which is three-dimensional data with reference to the traveling apparatus 1 on the traveling road surface.

Subsequently, the obstacle detection unit 155 moves the road surface point-cloud data that has been stored using the odometry information (step S13). There may be no odometry information when, for example, the traveling apparatus 1 is not moving.

The obstacle detection unit 155 then performs plane detection using the acquired road surface point-cloud data and calculates the inclination of the ground from the result of plane detection (step S14). Specifically, the obstacle detection unit 155 extracts the road surface point-cloud data in a predetermined rectangular range (e.g., having a vertical length x of 1.0 meter and a horizontal length y of 1.4 meters) from the acquired road surface point-cloud data, and performs the plane detection using the extracted data. The predetermined rectangular range may be set by a manufacturer or a user. The obstacle detection unit 155 calculates the pitch angle from the detected plane and outputs the pitch angle as the inclination of the ground.

The obstacle detection unit 155 then corrects the inclination of the acquired road surface point-cloud data using the calculated inclination of the ground (step S15).

The obstacle detection unit 155 then removes the road surface point-cloud data within the rectangle of the traveling apparatus 1 from the acquired road surface point-cloud data in which the inclination has been corrected, to exclude the sensor data corresponding to the traveling apparatus 1 itself (step S16).

The obstacle detection unit 155 stores the road surface point-cloud data in which the inclination correction and the above-described removal have been performed (step S17). The obstacle detection unit 155 holds the latest 2-second data of the road surface point-cloud data and deletes older data.

With the above-process, the front-rear sway of the traveling apparatus 1 traveling on rough ground is corrected, and corrected traveling road surface data which is detailed road surface point-cloud data can be obtained.

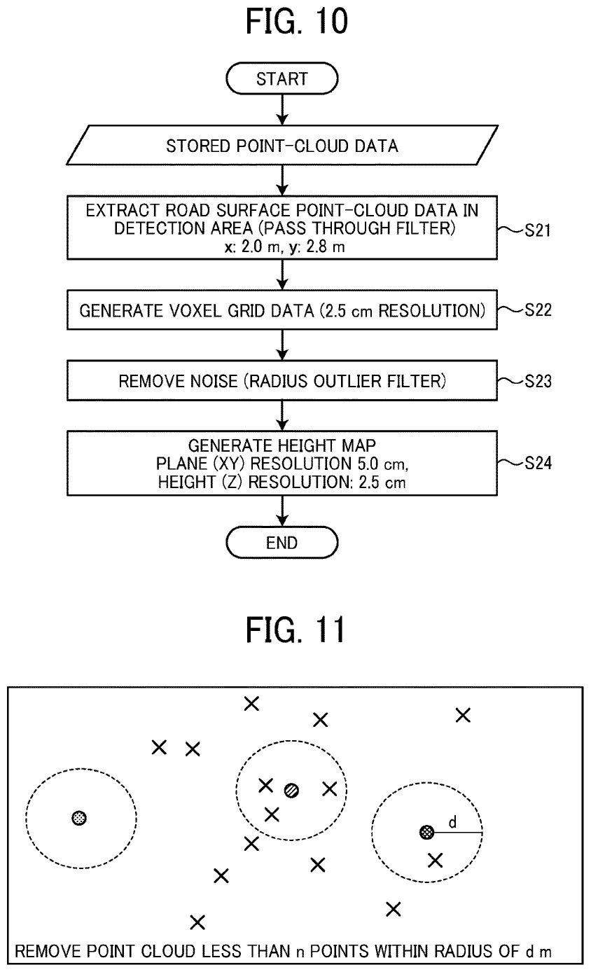

A description is given below of the process of generating a height map (step S2 in FIG. 8). FIG. 10 is a flowchart of the process of generating a height map according to the present embodiment.

As illustrated in FIG. 10, the height map is generated in the following order of process using the stored road surface point-cloud data generated as described above.

As illustrated in FIG. 10, the obstacle detection unit 155 extracts the road surface point-cloud data in the detection range with a pass through filter (step S21). The detection range is a rectangle area having a vertical length x of 2.0 meters and a horizontal length y of 2.8 meters from the center of the robot (the traveling apparatus 1) as viewed from the front of the bumper 16 (see FIG. 1).

Subsequently, the obstacle detection unit 155 generates voxel grid data using the road surface point-cloud data within the detection range (step S22). The resolution is 2.5 centimeters.

The obstacle detection unit 155 then performs noise removal with a radius outlier filter (step S23). FIG. 11 is a diagram illustrating an outline of the noise removal. Specifically, the obstacle detection unit 155 removes a data point if, for example, the number of other data points within the radius d meter of that data point is smaller than n in the point cloud distribution as illustrated in FIG. 11. The removed data points are indicated by cross marks in FIG. 11.

The obstacle detection unit 155 then generates a height map using the voxel grid data from which noise has been removed (step S24). The resolution is 5.0 centimeters in xy plane and 2.5 centimeters in height (z). In one embodiment, the maximum of their respective z values of the data points included in a voxel is held as the height value of that voxel. The obstacle detection unit 155 generates a map in which the maximum of their respective z values of multiple voxels having certain xy values is held as the height value of the position indicated by the xy values. The map thus generated is a height map in which the maximum height from the traveling road surface is held on a two-dimensional map.

The above-described process yields a height map from which noise is removed. This height map has the effect of reducing the processing load (increasing the processing speed) due to the reduction in the number of point groups and allowing the traveling apparatus 1 to travel on gratings because the resolution is relatively rough.

When traveling outdoors, the traveling apparatus 1 needs to detect ditches as road surface obstacles because of the risk of falling of the traveling apparatus 1. In many sites, however, reticulated ditch grates (gratings) are installed to allow traveling apparatuses. Since the traveling apparatus 1 can travel on gratings, it is desired to detect gratings as travelable areas not road surface obstacles. If point groups are observed minutely, a mesh-shaped grating has both a flat portion and a portion erroneously detected as a ditch. The erroneous detection of a ditch may prevent the traveling apparatus 1 from traveling on the grating. When the two-dimensional map is converted into a height map having a relatively rough resolution of cells, point groups are not observed locally, which allows a grating to be detected as a traveling road surface not erroneously detected as a ditch. In the present embodiment, the resolution of the height map is set to 5.0 centimeters in consideration of the size of the crawlers of the traveling apparatus 1.

The noise removal in step S23 will be described in detail below.

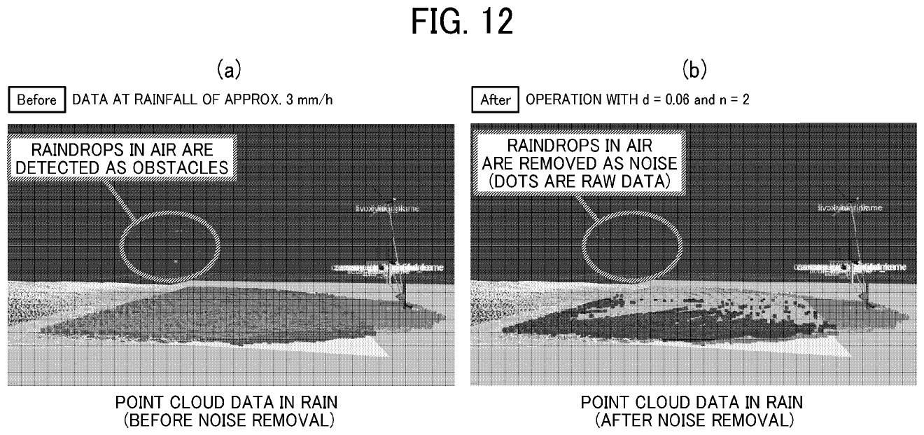

FIG. 12 is a diagram illustrating a result of noise removal according to the present embodiment. In the rain, the 3D LiDAR sensor being the range sensor 113 may erroneously detect raindrops. When the amount of rainfall increases, as illustrated in (a) of FIG. 12, point clouds scattered in the air are erroneously detected although there is no obstacle in the air. If the height map is converted as it is, raindrops may be detected as obstacles, and the traveling apparatus 1 may stop or take an avoidance action even in a place without obstacles.

Accordingly, in the present embodiment, the noise removal as illustrated in FIG. 11 is performed to remove the raindrops as noise to enable the obstacle detection function even in the rain.

The noise removal as illustrated in FIG. 11 is processing of removing data points when the number thereof within a radius d m of a target point is smaller than n. In FIG. 12, (b) illustrates the result of performing the noise removal of FIG. 11 with the radius d of 0.06 meter and the number of data points n of 2. In the result, the raindrops in the air are removed compared to the result in (a) of FIG. 12. Removing the erroneous detection data due to the raindrops in the rain by the noise removal enables the traveling apparatus 1 to cope with rain, i.e., to carry out the obstacle detection function.

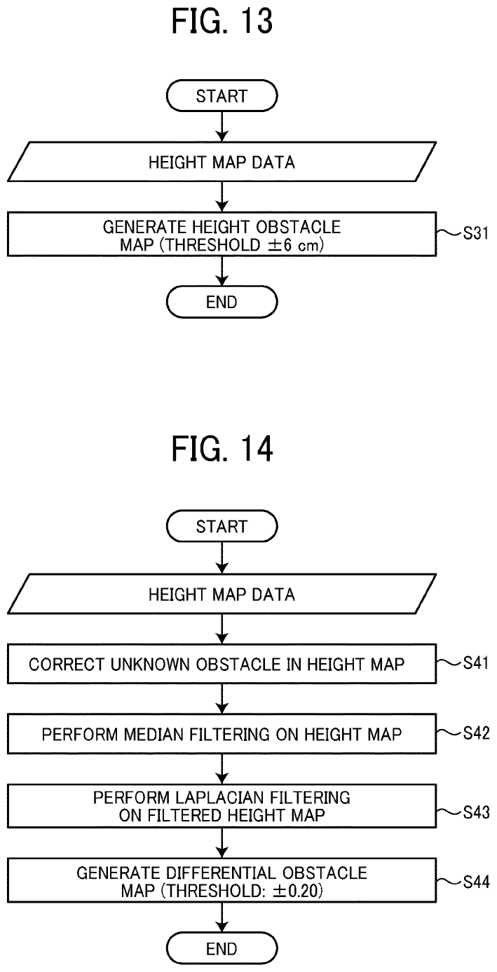

A description is given below of the process of generating a height obstacle map (step S3 in FIG. 8). FIG. 13 is a flowchart of the process of generating a height obstacle map according to the present embodiment. As illustrated in FIG. 13, in generating a height obstacle map, the following processing is performed using height map data.

As illustrated in FIG. 13, the obstacle detection unit 155 sets the threshold to ±6 centimeters and generates the height obstacle map (step S31). More specifically, on the two-dimensional map, the obstacle detection unit 155 sets a value of 100 to a cell higher than the threshold of +6 centimeters as an ordinary obstacle cell, sets a value of 99 to a cell lower than −6 centimeters as a ditch obstacle cell, sets a value of −1 to a cell having no point-cloud data as a so-called unknown obstacle cell, and sets a value of 0 to other cells as travelable area cells. This processing yields a height obstacle map in which the cells are classified into four types: ordinary obstacle cells, ditch obstacle cells, unknown obstacle cells, and travelable area cells. Conditional branch of processing is available with the values assigned to the cells of the two-dimensional map.

A description is given below of the process of generating a differential obstacle map (step S4 in FIG. 8). FIG. 14 is a flowchart of the process of generating a differential obstacle map according to the present embodiment. As illustrated in FIG. 14, in the process of generating a differential obstacle map, processing is performed in the following order using height map data.

As illustrated in FIG. 14, the obstacle detection unit 155 corrects the unknown obstacle cell in the height map (step S41). In the height map, the so-called unknown obstacle cell having no point-cloud data is present because of, for example, the influence of occlusion of an obstacle. The obstacle detection unit 155 stores, in the unknown obstacle cell, the average height of the four neighboring cells on the two-dimensional map to correct the unknown obstacle cell. The obstacle detection unit 155 stores a height value of 0 when all of the four neighboring cells are unknown obstacle cells.

Subsequently, the obstacle detection unit 155 performs median filtering on the corrected height map (step S42).

The obstacle detection unit 155 then performs Laplacian filtering on the corrected height map having been subjected to median filtering to generate a differential map (step S43).

The obstacle detection unit 155 then sets the thresholds to ±0.20 and generates a differential obstacle map using the differential map generated by the Laplacian filter (step S44). On the two-dimensional map, the cells having a value larger than the threshold value +0.20 or the cells having a value smaller than the threshold value −0.20 are assigned with a value of 100 as the differential obstacle cells, and the other cells are assigned with a value of 0 as the travelable area cells.

The above-described process yields a differential obstacle map in which cells are classified into two types: differential obstacle cells and travelable area cells. A differential map is a map in which a difference in height from the neighboring cell on the height map is represented as a numerical value. The greater the difference in height from the neighboring cell, the greater the value assigned to the cell. For example, the value is larger in a portion where neighboring cells have a sharp difference in height, such as a curb, i.e., where there is a standing edge. As a result, the smoothness of the height map can be known.

The correction in step S41 is for performing median filtering, and median filtering in step S42 is for smoothing variations in the height of the height map due to the noise of the range sensor 113.

Such a result obtained by classifying the cells on a differential with threshold values is called a differential obstacle map. A cell having a value equal to or greater than the threshold value indicates a portion, such as a curb, where there is a standing edge and is a candidate for an obstacle.

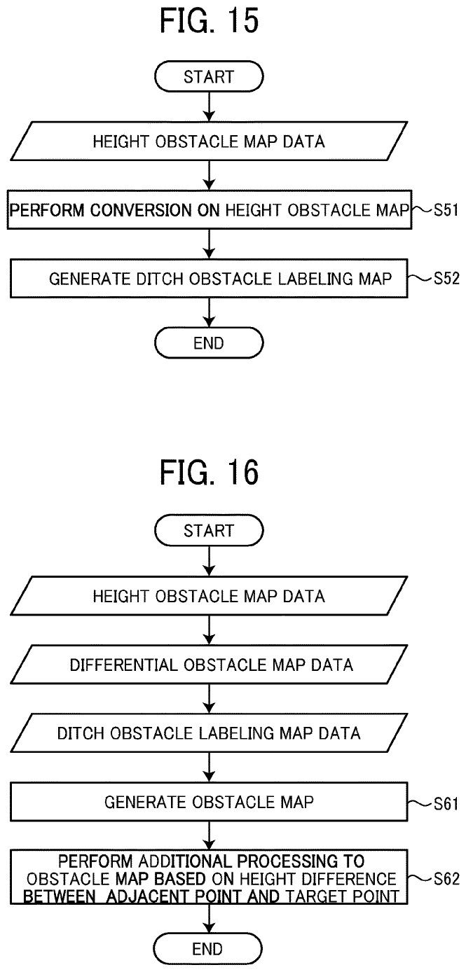

A description is given below of the process of generating a ditch obstacle labeling map (step S5 in FIG. 8). FIG. 15 is a flowchart of the process of generating a ditch obstacle map according to the present embodiment. As illustrated in FIG. 15, in the process of generating a ditch obstacle labeling map, processing is performed in the following order using the height obstacle map data.

As illustrated in FIG. 15, the obstacle detection unit 155 firstly performs conversion processing on the height obstacle map (step S51). More specifically, when the eight neighboring cells surrounding an unknown obstacle cell includes a ditch obstacle cell on the height obstacle map, the obstacle detection unit 155 converts the target unknown obstacle cell into a ditch obstacle cell.

Subsequently, the obstacle detection unit 155 generates a ditch obstacle labeling map using the converted height obstacle map (step S52). More specifically, the obstacle detection unit 155 performs labeling on the eight neighboring cells of the ditch obstacle cell.

The above-described process yields labeling (clustering) of the ditch obstacle on the height obstacle map.

Regarding step S51, when a ditch is viewed by a 3D-LiDAR sensor, unknown obstacle cells are often caused by occlusion. Accordingly, the conversion processing is performed to convert the unknown obstacle cells to the ditch obstacle cells on the assumption that the unknown obstacle cells adjacent to a ditch obstacle cell are of the same ditch.

A description is given below of the process of generating an obstacle map (step S6 in FIG. 8). FIG. 16 is a flowchart of the process of generating an obstacle map according to the present embodiment. As illustrated in FIG. 16, in the process of generating an obstacle map, processing is performed in the following order using data of three maps, i.e., the height obstacle map, the differential obstacle map, and the ditch obstacle labeling map obtained by the processes so far.

As illustrated in FIG. 16, the obstacle detection unit 155 integrates the three data, i.e., the height obstacle map data, the differential obstacle map data, and the ditch obstacle labeling map data to generate an obstacle map (step S61). More specifically, the obstacle detection unit 155 observes the same cell in the differential obstacle map and the height obstacle map and, when the cell has the value of 99 (ditch obstacle) or 100 (curb obstacle) in both maps, performs an AND operation to makes the cell an obstacle cell. At this time, in the case of ditch obstacle, all the cells labeled as obstacle are converted into obstacle cells.

Subsequently, the obstacle detection unit 155 performs additional processing on the obstacle map to facilitate the detection of ditch obstacles (step S62). The additional processing is detecting a ditch obstacle from the difference in height between the target point and neighboring points (cells) on the height map.

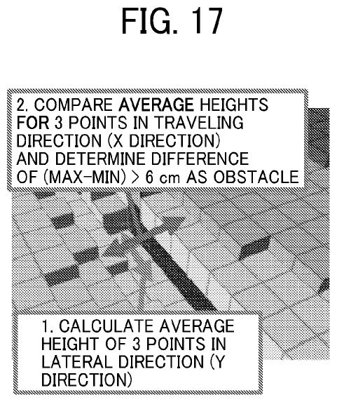

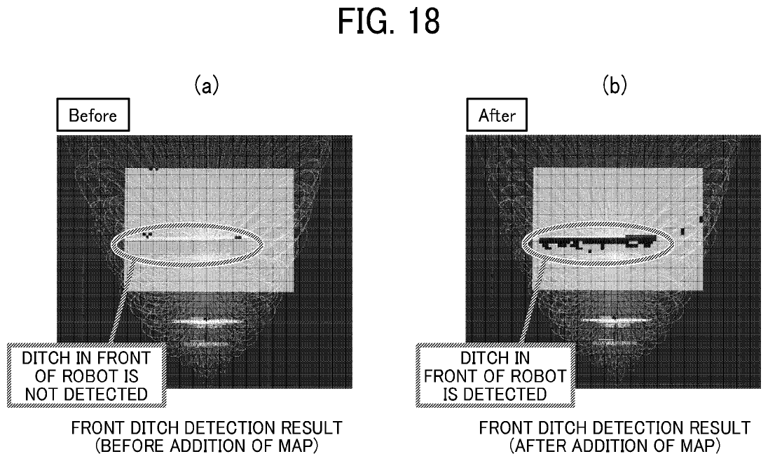

FIG. 17 is a diagram illustrating an overview of the additional processing on the obstacle map according to the present embodiment. FIG. 18 is a diagram illustrating a result of the application of the additional processing on the obstacle map according to the present embodiment. The obstacle detection unit 155 calculates the average height of three cells (three points), i.e., a target cell and the cells on the left and right thereof, arranged in the lateral direction (Y direction) of the traveling apparatus 1.

The obstacle detection unit 155 compares the calculated average heights among three cells in the traveling direction (X direction) of the traveling apparatus 1. The obstacle detection unit 155 determines that the cell is an obstacle cell when, for example, the difference between the maximum and the minimum of the average heights of the three cells is larger than 6 centimeters as illustrated in FIG. 17.

The sensitivity of detection of a ditch obstacle in front is low as illustrated in (a) of FIG. 18 if only the processing of step S61 is performed. Accordingly, the additional processing of step S62 is also executed on the obstacle map to increase the sensitivity of detection. The additional processing on the obstacle map achieves the detection of a ditch obstacle in front with high sensitivity as illustrated in (b) of FIG. 18.

The above-described process yields an obstacle map including both ditch obstacles and curb obstacles.

In step S61, since an obstacle is determined based on the height difference and the smoothness, the height obstacle map corresponding to the height difference and the differential obstacle map corresponding to the smoothness are integrated. Further, a ditch obstacle, which is not always determined by an AND operation of the height difference and the smoothness, is determined using the labeling (cluster) map data for ditch obstacles. When any one of the cells on the same label map is applicable to the AND operation with an edge cell on the differential obstacle map, all cells having that label are determined to be ditch obstacle cells.

As described above, according to the present embodiment, the range sensor 113 employing 3D LiDAR performs scanning obliquely downward, the data obtained from the range sensor 113 is subjected to vibration correction by plane detection, and then the corrected data is superimposed over time to acquire detailed road surface data. The obtained vibration-corrected detailed road surface data is converted into a height map in which the maximum height is held in cells of a two-dimensional map such that the relationship in height in the front-rear, left-right, and oblique directions can be grasped. An obstacle is determined from the difference in height on the height map in the front-rear, left-right, and oblique directions. Accordingly, the road surface obstacle detection using three-dimensional sensor data can be performed with reduced influences of fluctuations in the approach angle of a traveling body to the road surface.

Further, according to the present embodiment, the presence of an obstacle on the traveling road surface is determined based on the height difference and the smoothness feature and further determined based on the height difference between neighboring points on the height map. As a result, obstacles on the traveling road surface can be detected sufficiently.

Although the first embodiment is described above, the details such as the specific configuration of each element and the specific content of processing are not limited to the above description.

### Operational Examples

A description is given below of operational examples of the traveling apparatus 1 according to the first embodiment.

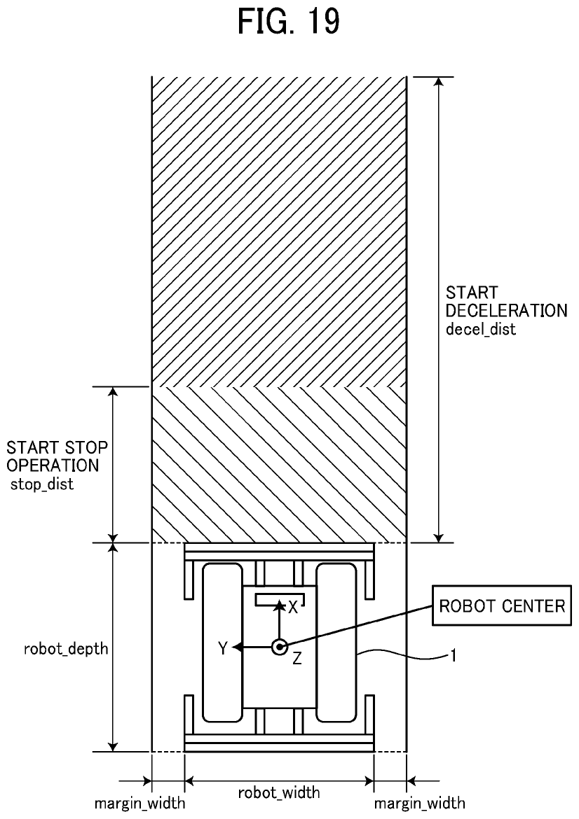

FIG. 19 is a diagram illustrating a deceleration range and a stop range of the traveling apparatus 1 according to the present embodiment. As an operational example, a stop of the traveling apparatus 1 during traveling is described. For stopping the traveling apparatus 1 during autonomous or manual traveling in response to the detection of an obstacle, a deceleration range and a stop range are defined as illustrated in FIG. 19.

When an obstacle is detected in the defined range, the traveling apparatus 1 outputs a speed for deceleration or stop to achieve the stop by obstacle detection.

The width of the deceleration/stop range is set to a robot robot_width (the width of the traveling apparatus 1) plus margins margin_width.

In the traveling direction (the vertical direction in, for example, FIG. 5), both a deceleration start distance decel_dist and a stop start distance (stop_dist) are set.

In principle, the deceleration start distance decel_dist is greater than the stop start distance stop_dist. Note that, in FIG. 19, the traveling apparatus 1 has a length robot_depth in the traveling direction.

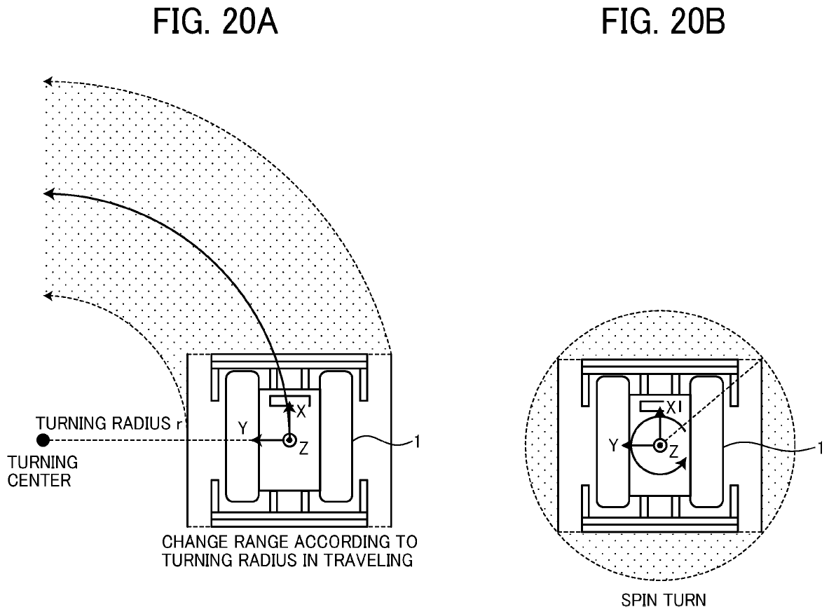

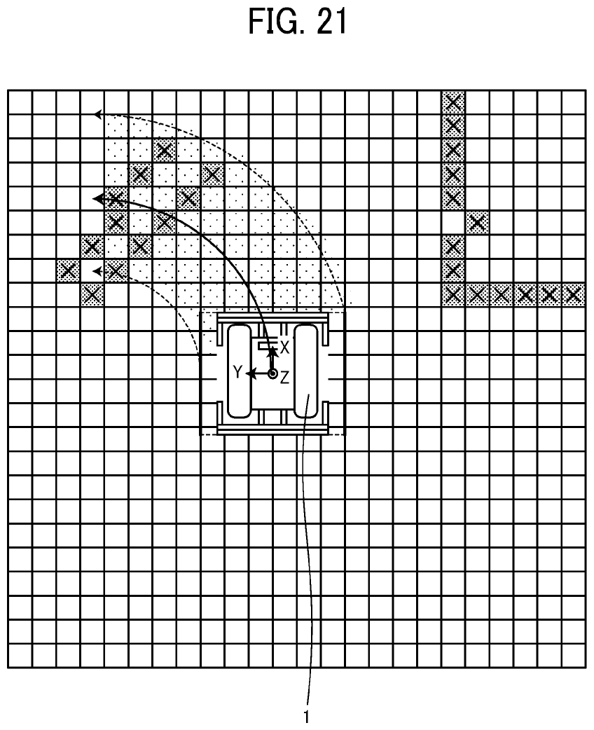

FIGS. 20A and 20B are diagrams each illustrating a change in the detection range with the turning radius of the traveling apparatus 1 according to the present embodiment. The traveling apparatus 1 can see the detected obstacle on the commanded track along which the traveling apparatus 1 is traveling by changing the deceleration range or the stop range with the track, specifically, the turning radius r as illustrated in FIG. 20A. The turning radius r can be calculated from a rectilinear speed v and the rotation angle ω specified in a speed command (r=v/ω). Further, in a spin turn, since the turning radius is 0, a circle having the radius from the center of the traveling apparatus 1 to the opposite angle of the body is a stop determination range. Accordingly, the range is extremely narrow as illustrated in FIG. 20B, and turning is easy even in a narrow place. When the rotation angle ω is 0, the turning radius is ∞, and thus exception handling is performed. Since the command is for straight traveling, the traveling apparatus 1 sets the range as a forward range as illustrated in FIG. 19.

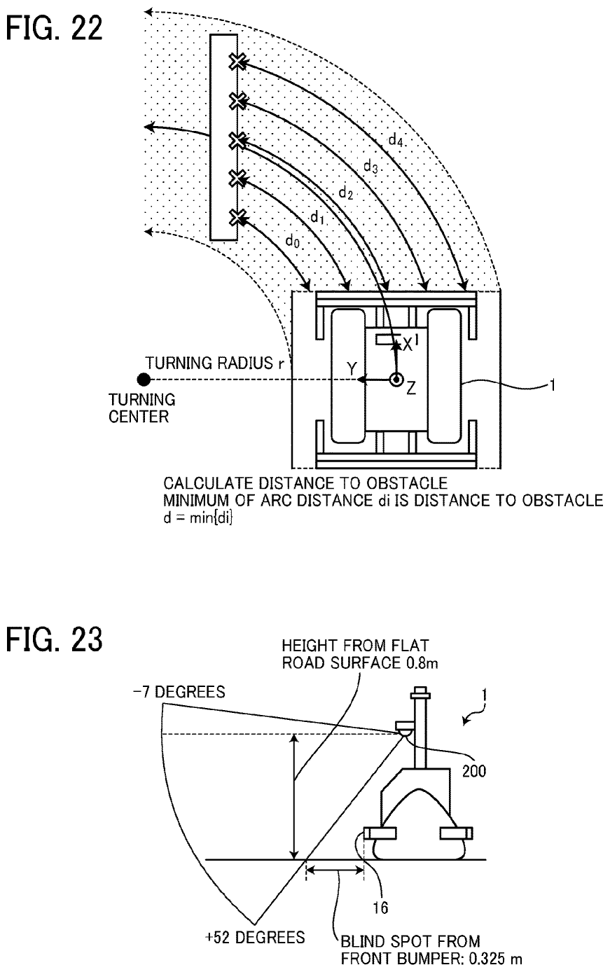

FIG. 21 is a diagram illustrating a detection area and representative points of an obstacle by costmap according to the present embodiment. FIG. 22 is a diagram illustrating a method of calculating the distance to an obstacle according to the present embodiment. The traveling apparatus 1 calculates the distance to an obstacle in a range ahead of the traveling apparatus 1 and determines whether to keep the current speed, decelerate, or stop traveling in accordance with the distance, thereby controlling the traveling in response to the detection of an obstacle. The distance to the obstacle is calculated by the following method.

The cell center of the costmap is set to the coordinates of the representative point, and the distance d to the obstacle is calculated from the representative points within the detection range changed as illustrated in FIG. 21.

Since the distance to an obstacle depends on the turning radius, the distance is calculated in the form of an arc.

As illustrated in FIG. 22, the shortest of distances d₀ to d₄ to the obstacle in the detection range is the distance to the obstacle.

The traveling apparatus 1 applies the distance to the obstacle to the decelerate/stop determination as follows.

The calculated distance d to the obstacle is applied to the deceleration/stop range in FIG. 19 to determine whether to keep the current speed, decelerate, or stop traveling.

Keep the speed command as it is when the distance d is greater than the deceleration start distance decel_dist (d>decel_dist).

Decelerate when the distance d is greater than the stop start distance stop_dist and smaller than the deceleration start distance decel_dist(stop_dist<d<decel_dist).

Stop (speed is 0) when the distance d is smaller than the stop start distance stop_dist (d<stop_dist).

In deceleration determination, the track (turning radius r) itself is left as it is. Accordingly, both the rectilinear speed v and the angular speed ω are reduced at a constant deceleration rate decel_rate. For example, the deceleration rate decel_rate is 50%.

In stop determination, both the rectilinear traveling and the turning are desired to be stopped. Accordingly, both the rectilinear speed v and the angular speed ω are instructed to be 0.

Use of the obstacle detection results according to the embodiments of the present disclosure allows the traveling apparatus 1 to safely stop considering the traveling track in response to the detection of road surface obstacles such as curbs and ditches, obstacles protruding into the air, or obstacles floating in the air.

A description is given of a second embodiment of the present disclosure.

In the second embodiment, instead of the range sensor 113 described in the first embodiment, a range sensor 200 having a different viewing angle from the range sensor 113 is used. In the following description of the second embodiment, descriptions of elements identical or similar to those in the first embodiment are omitted, and differences from the first embodiment are described.

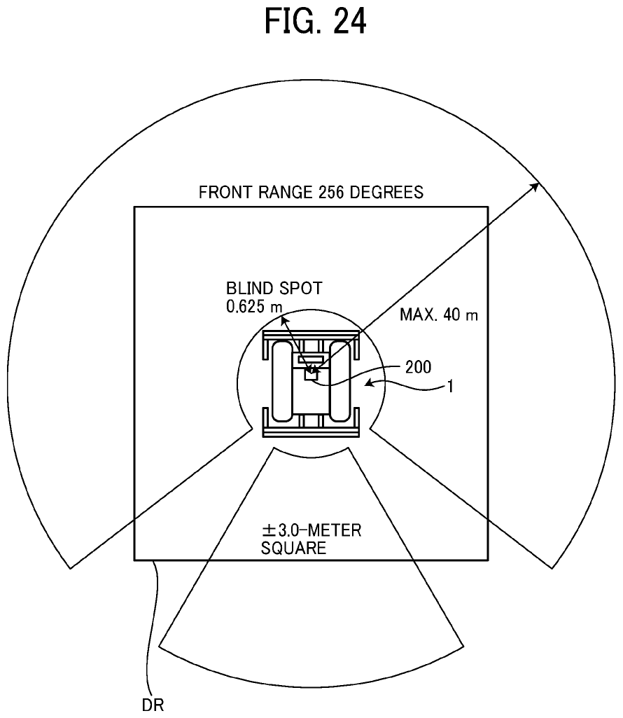

FIG. 23 is a side view of a traveling apparatus 1 according to the second embodiment. FIG. 24 is a plan view of the traveling apparatus 1 as viewed from above.

The range sensor 200 for oblique direction detection is a three-dimensional range sensor employing 3D LiDAR and employs non-repetitive scanning that achieves the full viewing angle of 360 degrees. The range sensor 200 for oblique direction detection is installed such that the irradiation angle of the laser beam is a predetermined depression angle relative to a horizontal traveling road surface. The range sensor 200 for oblique direction detection is disposed at a height of 0.8 meter, at a depression angle of 52 degrees, and at an elevation angle of 7 degrees, on the front side of the traveling apparatus 1 in the traveling direction of the main body 10. This installation position is determined to allow the range sensor 200 to detect the traveling road surface up to a position in front of the bumper 16 on the front side of the traveling apparatus 1. Due to the measurement range of the range sensor 200, blind spots are present at the feet and in the height direction. The blind spot from the bumper 16 is 0.325 meter.

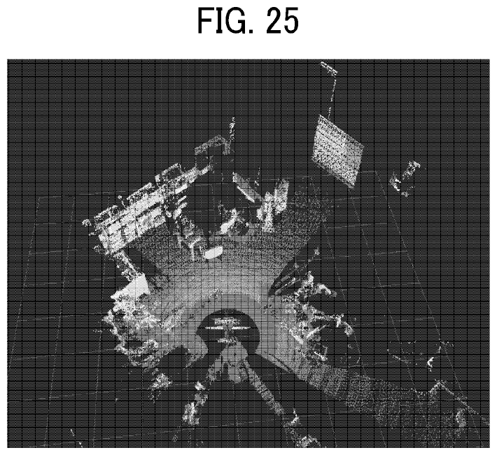

FIG. 25 is a diagram illustrating actual measurement data obtained by the range sensor 200 according to the present embodiment. As illustrated in FIG. 25, the range sensor 200 according to the present embodiment acquires point-cloud data in 360 degrees and increases a detection coverage DR of obstacles (see FIG. 24). In the first embodiment, the measurement range is the conical range of about 70 degrees as viewed from the center of the sensor detection surface. The traveling apparatus 1 of the present embodiment, however, has blind spots as illustrated in FIG. 25 due to, for example, the limitations in the attachment of the range sensor 200.

Use of the range sensor 200 of the present embodiment enables the acquisition of 360-degree point-cloud data around the traveling apparatus 1, thereby detecting obstacles on the lateral sides and at the rear which are not detected by the range sensor 113 of the first embodiment. Accordingly, the traveling apparatus 1 of the present embodiment can safely avoid obstacles or stop in consideration of the track in the case of obstacles on the lateral sides or at the rear. In other words, since the traveling apparatus 1 of the present embodiment detects obstacles on the lateral side or at the rear, the traveling apparatus 1 can perform an avoidance operation for the obstacle on the lateral side or at the rear, thereby increasing the safety.

Installation of multiple range sensors 113 of the first embodiment enables the acquisition of the point-cloud data of all around the traveling apparatus 1 so as to detect obstacles in 360 degrees. Use of the multiple range sensors 113, however, increases the cost. In addition, the weight of the crawler robot itself increases by the multiple sensors, which increases the load on the hardware of the crawler robot.

Use of the single range sensor 200 of the present embodiment is advantageous in achieving both the increase of the obstacle detection range and the reduction of the cost and the load on the hardware.

As described above, the traveling apparatus 1 of the present embodiment can balance “safety” and “cost” by using the range sensor 200.

The change of the 3D LiDAR range sensor for detecting the traveling road surface from the range sensor 113 of the first embodiment to the range sensor 200 of the present embodiment that acquires point-cloud data in 360 degrees does not affect the method of obstacle detection. Based on the three-dimensional traveling road surface data obtained from the range sensor 200 of the present embodiment, a height map that holds height information indicating the height from the traveling road surface is generated, and an obstacle is detected from the difference in height in the height map.

However, use of the range sensor 200 of the present embodiment increases the amount of information to be acquired due to the increase of the detection range to the full 360-degree range, and the processing load of the obstacle detection increases. Accordingly, the process of converting three-dimensional data into a two-dimensional height map and then detecting an obstacle on the map makes the most of the “height mapping” in terms of reduction of the processing load. Needless to say, when the obstacle detection is performed on the three-dimensional data, the processing load is considerably large, and it is difficult to detect an obstacle in real time while the traveling apparatus 1 is autonomously traveling. Performing the detection after converting three-dimensional data into a two-dimensional height map reduces the processing load, thereby enabling the implementation of the range sensor 200 of the present embodiment. Compared with the range sensor 113 of the first embodiment, the range sensor 200 of the present embodiment, which increases the amount of information, achieves a higher effect of height mapping in terms of reducing the processing load.

As described above, according to the present embodiment, use of the range sensor 200 that acquires the point-cloud data in 360 degrees reduces the processing time by the height mapping while increasing “safety.” Thus, the present embodiment make the most of the height mapping.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

Each of the functions of the above-described embodiments of the present disclosure may be implemented by one or more processing circuits or circuitry. The term “processing circuit or circuitry” in the present specification includes a programmed processor to execute the functions by software, such as a processor implemented by an electronic circuit; and devices, such as an application-specific integrated circuit (ASIC), a digital signal processor (DSP), a field-programmable gate array (FPGA), and other circuit modules designed to perform the above-described functions, using one or more programs stored in one or more memories.

This patent application is based on and claims priority to Japanese Patent Application Nos. 2023-047196, filed on Mar. 23, 2023, and 2023-201928, filed on Nov. 29, 2023, in the Japan Patent Office, the entire disclosure of which is hereby incorporated by reference herein.

### REFERENCE SIGNS LIST

1 Traveling body (Obstacle detection apparatus)
11a, 11b Crawler traveling body (driver)
113 Three-dimensional range sensor
155 Obstacle detection unit

1. An obstacle detection apparatus, comprising:
a three-dimensional range sensor disposed on a front side of a traveling body in a traveling direction in which the traveling body travels on a road surface, the three-dimensional range sensor having an irradiation angle of laser beam being a depression angle relative to the road surface; and
obstacle detection circuitry configured to detect an obstacle on the road surface by using a height map based on three-dimensional road surface data obtained from data acquired by the three-dimensional range sensor, the height map holding height information indicating a height from the road surface.

2. The obstacle detection apparatus according to claim 1, wherein:
the three-dimensional road surface data is three-dimensional data with reference to the traveling body, and
the height map is a two-dimensional map that holds a maximum height from the road surface as the height information.

3. The obstacle detection apparatus according to claim 2, wherein:
the three-dimensional road surface data is subjected to vibration correction by plane detection and superimposed over time to generate corrected road surface data, and
the obstacle detection circuitry is configured to generate the height map based on the corrected road surface data.

4. The obstacle detection apparatus according to claim 2, wherein:
the three-dimensional range sensor is disposed at a height and an inclination angle that make the road surface detectable up to a position in front of a front end of the traveling body in the traveling direction.

5. The obstacle detection apparatus according to claim 2, wherein the obstacle detection circuitry is configured to:
determine whether a height obstacle is present on the road surface based on a height difference and a smoothness feature; and
determine whether a ditch obstacle is present on the road surface based on a height difference in neighboring points on the height map.

6. The obstacle detection apparatus according to claim 3, wherein:
the obstacle detection circuitry is configured to generate a voxel grid based on a result of the vibration correction, to generate the height map.

7. The obstacle detection apparatus according to claim 3, wherein:
the obstacle detection circuitry is configured to perform noise removal based on a point group distribution of a result of the vibration correction.

8. The obstacle detection apparatus according to claim 2, wherein:
the traveling body includes a crawler traveling body having a ground contact length as a driver, and
the obstacle detection circuitry unit is configured to detect the obstacle based on a determination parameter that suits the driver.

9. The obstacle detection apparatus according to claim 1, wherein:
the three-dimensional range sensor is configured to acquire the three-dimensional road surface data in 360 degrees.

10. A traveling body, comprising:
a driver configured to travel on a road surface;
a three-dimensional range sensor disposed on a front side of the traveling body in a traveling direction in which the driver travels, the three-dimensional range sensor having an irradiation angle of laser beam being a depression angle relative to the road surface; and
obstacle detection circuitry configured to detect an obstacle on the road surface by using a height map based on three-dimensional road surface data obtained from data acquired by the three-dimensional range sensor, the height map holding height information indicating a height from the road surface.

11. (canceled)

12. A non-transitory recording medium storing a plurality of program codes which, when executed by one or more processors, causes the processors to perform an obstacle detection method, comprising:
generating a height map based on three-dimensional road surface data obtained from data acquired by a three-dimensional range sensor, the height map holding height information indicating a height from a road surface, wherein the three-dimensional range sensor is disposed on a front side of a traveling body in a traveling direction in which the traveling body travels on the road surface and has an irradiation angle of laser beam being a depression angle relative to the road surface; and
detecting an obstacle on the road surface by the height map.
